(19) United States
(12) Patent Application Publication
(10) Pub. No.: US 2018/0084796 A1
(43) Pub. Date: Mar. 29, 2018

(54) FOAMABLE MILK COMPOSITION

(71) Applicant: DMK Deutsches Milchkontor GmbH, Zeven (DE)

(72) Inventor: Katja Borcherding, Zeven (DE)

(21) Appl. No.: 15/690,490

(22) Filed: Aug. 30, 2017

(30) Foreign Application Priority Data
Sep. 28, 2016 (EP) 16 191 066-6

(51) Int. Cl. A23C 9/152; A23C 9/142; A23P 30/40; A23C 9/148

(52) U.S. Cl. CPC A23C 9/152; A23C 9/148; A23P 30/40; A23C 9/1422

(57) ABSTRACT

Suggested is a foamable dairy composition, containing or consisting of:
(a) at least one dairy product, and
(b) an additive which is obtained by subjecting a dairy product to filtration, separating the permeate which is optionally subjected to a thermal post-treatment.

### FIELD OF THE INVENTION

The invention is in the field of dairy produce and relates to dairy products with added milk permeates for improved foam formation, a process for the composition of the dairy products, and use of the milk permeates.

### STATE OF THE ART

Milk foams are essential for many coffee specialties. They are formed by foaming [or frothing or steaming] milk or dairy products, in the process of which proteins and fats are forming structures which encase air bubbles. When preparing milk foam for various coffee-based, particularly espresso-based beverages such as latte macchiato or cappuccino, milk is mixed with air. In addition to the fat content and the temperature of the milk, the pore size of the foam also depends on the time of its composition. By controlling these parameters, the chemical equilibrium in the emulsion may be varied. Physical and chemical factors influencing the milk foams are described in the doctoral thesis of K. Borcherding entitled “Untersuchungen zur Charakterisierung der Makro- and Mikrostruktur von Milchschäumen”, University of Kiel (urn:nbn:de:gbv:8-diss-13056) from the year 2004.

Machines for the production of coffee beverages, which are equipped with an additional device for the production of milk foam, are also sufficiently known, for example, from EP 2658420 A1 (JURA).

It is disadvantageous that the foam, particularly when prepared by a machine, frequently collapses rapidly, which does not cause it to taste less good, but optically the beverage is less appealing. It is also disadvantageous that, depending on the milk used, only an insufficient amount of foam is produced from time to time.

The task of the present invention was therefore to provide dairy products which are characterised in that they develop a strong and stable foam when foamed. It would also be preferred if by adding a foaming composition also an improvement in taste is obtained.

### DESCRIPTION OF THE INVENTION

A first subject-matter of the invention relates to a foamable milk composition, containing or consisting of
(a) at least one dairy product, and
(b) an additive which is obtained by subjecting a dairy product to filtration, separating the permeate, and, optionally, subjecting it to a thermal post-treatment.

Surprisingly, it was found that already the addition of small amounts of milk permeates which form group (b) causes the dairy products to form more foam when foamed, and also that said foam remains stable for a longer period of time. Alternatively, it is possible to foam the permeates directly and to add them to the dairy products. It was also not to be expected to find that, in addition, the permeates are causing an improvement in taste in various products.

### BRIEF DESCRIPTION OF THE DRAWING

The present invention will be described in greater detail with reference to the accompanying drawing which illustrates two examples of the dairy product in accordance with the present invention.

### DAIRY PRODUCTS

As a basic component, the foamable dairy products may contain skimmed milk, milk with a set fat content, pasteurised milk, high temperature treated milk, ultra high temperature treated milk, condensed milk, whey, fine whey, soured milk, soured milk products, cream, yoghurt, kefir and ayran and their mixtures. It is, preferably, skimmed milk and milk with a set fat content. The foamed dairy products may be consumed as they are, such as, for example, as milk foam, in coffee or the like, or as a component for further food compositions such as soups and sauces.

Permeates

Suitable additives for those dairy products that allow a more vigorous formation of foam and a more stable foam are permeates from the filtration of skimmed milk, skimmed milk concentrates, milk with a set fat content, concentrates of milk with a set fat content, pasteurised milk, high temperature treated milk, ultra high temperature treated milk, condensed milk, whey, fine whey, soured milk or soured milk products. Such “milk permeates” have been known for a long time, particularly permeates on the basis of skimmed milk. They are aqueous substances obtained during the filtration process where proteins and milk fat are removed from the product used. What remains are vitamins, minerals and lactose.

Currently, the field of application of milk permeates is not too extensive: when the fractions are not directly processed any further during the process of, for example, the production of quark cheese (see, e.g., DE 10 2012 10049511, FINNAH), they are particularly used for the production of the Turkish specialty ayran which consists of water, diluted yoghurt and salt. Beyond that, milk permeate may serve as a culture medium for various microorganisms (EP 2725098 A1, QUEIZUAR) or as a component of high-fibre foods (EP 2887814 B1, GERVAIS).

In principle, all known filtration methods are suitable for the production of permeates, such as: diafiltration, microfiltration, ultrafiltration, nanofiltration, reverse osmosis, electrodialysis or a combination of these steps as described in more detail below.

Usually, the foamable dairy products contain the permeates in quantities from about 0.25 to about 20% by weight, preferably from about 1 to about 10% by weight, and particularly from about 2.5 to about 7.5% by weight of the additive (b).

Process

A further subject-matter of the invention relates to a process for the production of a foamed milk composition, comprising the following steps:
(a1) providing a first dairy product (a);
(a2) providing a second dairy product (b);
(a3) subjecting the second dairy product to filtration, obtaining a permeate and a retentate;
(a4) optionally, heat treatment of the permeate;
(a5) adding the optionally heat-treated permeate obtained from the second dairy product
   (b) to the first dairy product (a); and
(a6) foaming the mixture while introducing air or inert gas
or
(b1) providing a first dairy product (a);
(b2) providing a second dairy product (b);
(b3) subjecting the second dairy product to filtration, obtaining a permeate and a retentate;
(b4) optionally, heat treatment of the permeate;
(b5) foaming the optionally heat-treated permeate while introducing air or inert gas; and
(b6) adding the foamed permeate obtained from the second dairy product (b) to the first dairy product (a)
or
(c1) providing a first dairy product (a);
(c2) providing a second dairy product (b);
(c3) subjecting the second dairy product to filtration, obtaining a permeate and a retentate;
(c4) optionally, heat treatment of the permeate;
(c5) adding the optionally heat-treated permeate obtained from the second dairy product (b) to the first dairy product (a);
(c6) heat-treatment of the mixture; and
(c7) foaming the mixture while introducing air or inert gas.

Dairy products which are suitable as starting products for component (b) are preferably selected from the group consisting of skimmed milk, milk with a set fat content, pasteurised milk, high temperature treated milk, ultra high temperature treated milk, condensed milk, whey, fine whey, soured milk or soured milk products and their mixtures.

The filtration process for the production of the permeates to be used according to the invention may be diafiltration, microfiltration, ultrafiltration, nanofiltration, reverse osmosis, electrodialysis or a combination of these processes, as they are explained in more detail in the following:

Microfiltration or Diafiltration

Membrane separation processes include microfiltration or diafiltration. The essential difference to ultrafiltration and nanofiltration is in the different pore sizes and in the different membrane structure as well as the materials and filter materials involved. Filtration through membranes having a pore size <0.1 μm is usually referred to as nanofiltration or ultrafiltration, while filtration at pore sizes >0.1 μm, specifically from about 0.1 to 1 μm, is commonly referred to as microfiltration or diafiltration. In both cases, this concerns purely physical, i.e. mechanical membrane separation methods which apply the principle of mechanical size exclusion: all particles in the fluids which are larger than the membrane pores are retained by the membrane. The driving force in both separation methods is the differential pressure between the inlet and the outlet of the filter area, which is between 0.1 and 10 bar. Depending on the area of application, the filter area material may consist of stainless steel, synthetic material, ceramics or textile fabric. Filter elements appear in different forms: candle filters, flat membranes, spiral coil modules, bag filters and hollow fibre modules, all of which are, in principle, suitable within the meaning of the present invention.

Both microfiltration and diafiltration within the meaning of the present invention may be performed “hot” or “cold”, i.e. within the temperature range from about 10 to about 60° C. However, it is preferred to work at temperatures in the range from about 40 to about 55° C.

Ultrafiltration and Nanofiltration

Ultrafiltration and nanofiltration are filtration processes from the field of membrane technology, by means of which macro-molecular substances and small particles may be separated from a medium and concentrated. The degree of separation is decisive for the difference between microfiltration, ultrafiltration and nanofiltration. If the cut-off limit (or also “cut-off”) is 100 nm or more, one is referring to microfiltration. If the cut-off limit is in the range between 2-100 nm, this is referred to as ultrafiltration. In the case of nanofiltration, the cut-off limit is below 2 nm. In each of these cases, this concerns purely physical, i.e. mechanical membrane separation methods which apply the principle of mechanical size exclusion: all particles in the fluids which are larger than the membrane pores are retained by the membrane. The driving force in both separation methods is the differential pressure between the inlet and the outlet of the filter area, which is between 0.1 and 10 bar.

The cut-off limits of ultrafiltration membranes are also indicated in form of the NMWC (Nominal Molecular Weight Cut-Off, also referred to as MWCO, Molecular Weight Cut Off, unit: Dalton). It is defined as the minimal molecular mass of more global molecules, 90% of which are retained by the membrane. In practice, the NMWC should be at least 20% lower than the molecular mass of the molecule to be separated. Further qualitative statements on filtration may be made by means of the flux (water value) (transmembrane flux or passage rate). Ideally, it is proportional to the transmembrane pressure and reciprocal to the membrane resistance. These sizes are determined both by the characteristics of the membrane used and by concentration polarisation and possibly occurring fouling. The passage rate relates to 1 m² of membrane area. Its unit is l/(m²h bar). In a particular embodiment of the invention, fouling may be counteracted by introducing carbon dioxide as described, for example, in WO 2016 126810 A1 (IDAHO MILK PRODUCTS).

Membranes which have a pore size in the range from about 1,000 to about 50,000 and, preferably, from about 5,000 to about 25,000 Dalton have proved to be particularly suitable for ultrafiltration. Pore sizes in the range from 100 to 5,000 and, preferably, about 500 to 2,000 Dalton are preferred for nanofiltration.

The material of the filter area—used both in ultrafiltration and in nanofiltration processes—may represent stainless steel, polymer materials, ceramics, aluminium oxide or textile fabric. Filter elements appear in different forms: candle filters, flat membranes, spiral coil membranes, bag filters and hollow fibre modules, all of which are, in principle, suitable within the meaning of the present invention. However, spiral coil membranes made of polymer materials or candle filters made of ceramics or aluminium oxide are preferably used, where the first form of embodiment has proved to be particularly preferred for ultrafiltration and the second one for nanofiltration.

Both ultrafiltration and nanofiltration within the meaning of the present invention may be performed “hot” or “cold”, i.e., within the temperature range from about 10 to about 60° C. However, it is preferred to work at temperatures in the range from 40 to about 55° C.

Reverse Osmosis

Reverse osmosis is a physical membrane process for the concentration of substances dissolved in liquids, in the process of which the natural osmotic process is reversed by means of pressure.

The principle of the process is that the medium in which the concentration of a particular substance is to be reduced is separated by a semi-permeable membrane from the medium in which the concentration is to be increased. The latter is subjected to a pressure which must be higher than the pressure created by the osmotic pressure for concentration equilibration. As a result of this, the molecules of the solvent can migrate in opposite direction to their “natural” osmotic spreading direction. The pressure forces them into the compartment in which dissolved substances are present in a less concentrated form. Typical pressures of reverse osmosis are in the range from 3 to 30 bar (desalination of drinking water) or up to 80 bar (desalination of sea water).

The osmotic membrane through which only the carrier liquid (solvent) is allowed to pass, retaining the dissolved substances (solute), must be able to withstand these high pressures. In case the pressure difference more than balances the osmotic gradient, the molecules of the solvent are passing through the membrane just like in a filter, while the “contaminating molecules” are retained. In contrast to a classic membrane filter, osmotic membranes do not have through pores. The ions and molecules rather migrate through the membrane by diffusing through the membrane material, as is described by the solution-diffusion model: the osmotic pressure increases with an increasing concentration difference. If the osmotic pressure becomes equal to the applied pressure, the process ceases. An osmotic equilibrium is present. A continuous discharge of concentrate may prevent this from occurring. During the discharge of concentrate, the pressure is either controlled by means of a pressure controller or used by means of a pressure exchanger to accumulate the pressure required at the inflow of the system.

Electrodialysis

Electrodialysis is an electro-chemically driven membrane process in which ion exchanger membranes are used in combination with an electric potential difference to separate ionic species from uncharged solvents, or from contaminations. To this end, the space between two electrodes in an electrodialysis separator is separated by a stack of alternating anion and cation exchanger membranes. Each pair of ion exchanger membranes forms a separate “cell”. In technical systems, these stacks consist of more than two hundred membrane pairs. If a direct electric current is applied to the electrodes, the anions migrate to the anode. The anions may simply pass the positively charged anion exchanger membranes but they are stopped at the respective negatively charged cation exchanger membrane. As the same process (obviously with opposite signs) is performed with the cations, the net effect of electrodialysis is a concentration of salts in the cells with odd numbers (anion exchangermembrane/cation exchanger membrane), while the cells with even numbers (cation exchanger membrane/anion exchanger membrane) suffer a depletion of salt. The solutions with increased salt concentrations are combined to form the concentrate, while the depleted solutions form the diluate.

It is recommended to finally treat the diluate with a cation exchanger (“polisher”) and, particularly, to separate any sodium ions that had been introduced by dialysis.

In a particular embodiment, skimmed milk or a skimmed milk concentrate is subjected to ultrafiltration in order to produce the permeates. In doing so, ultrafiltration is preferably performed with a membrane having an average pore size in the range from about 1,000 to about 50,000 Dalton, preferably about 15,000 to about 25,000 Dalton and/or at temperatures in the range from about 35 to about 60° C. and, preferably, about 40 to 55° C.

A further preferred variant is that the permeate, optionally, after heat treatment, is added to skimmed milk or milk with a set fat content, which is subsequently subjected to pasteurisation, high temperature treatment or ultra high temperature treatment.

Thermal Post-Treatment

Although the permeates are employable already directly after filtration, it is recommended to subject them to thermal post-treatment. This is understood as heating the permeates to a temperature from, preferably, about 72 to 150° C., and particularly about 90 to 140° C., preferably, for a period of time from about 4 seconds to 5 minutes and particularly about 1 to 3 minutes.

Usually, permeates in quantities from about 0.25 to about 20% by weight, preferably from about 1 to about 10% by weight, and particularly from about 2.5 to about 7.5% by weight are added to the foamable dairy products forming component (a).

### INDUSTRIAL APPLICATION

A further subject-matter of the invention relates to the use of the permeate obtained from the filtration of a dairy product as a foaming agent and/or a foam stabiliser for dairy products. Here, a permeate obtained from the ultrafiltration of skimmed milk is employed whereby the quantities used typically amount to about 0.25 to about 20% by weight, based on the dairy products.

### EXAMPLES

### Example 1

Skimmed milk was subjected to ultrafiltration with a spiral coil membrane (separation performance 25,000 Dalton) at a temperature of 45° C. The permeates such obtained were placed into a measuring cylinder, either without undergoing heat treatment or after being heated to temperatures of between 95 and 140° C. for a period of 1 minute, were foamed with a stirrer at top speed for 1 minute, and subsequently, the foam height was determined as a function of time. The results are summarised in Table 1. Examples 1 to 4 are according to the invention, comparison example V1 was performed with skimmed milk without any additives.

TABLE 1
Foam height and foam stability (ml)

| | | Immediately | | | After |
|---|---|---|---|---|---|
| Expl. | Temperature | afterwards | After 5 min | After 10 min | 30 min |
| V1 | | 40 | 20 | 0 | 0 |
| 1 | untreated | 150 | 110 | 80 | 30 |
| 2 | 95° C. | 200 | 180 | 120 | 60 |
| 3 | 125° C. | 250 | 220 | 200 | 150 |
| 4 | 140° C. | 180 | 160 | 100 | 50 |

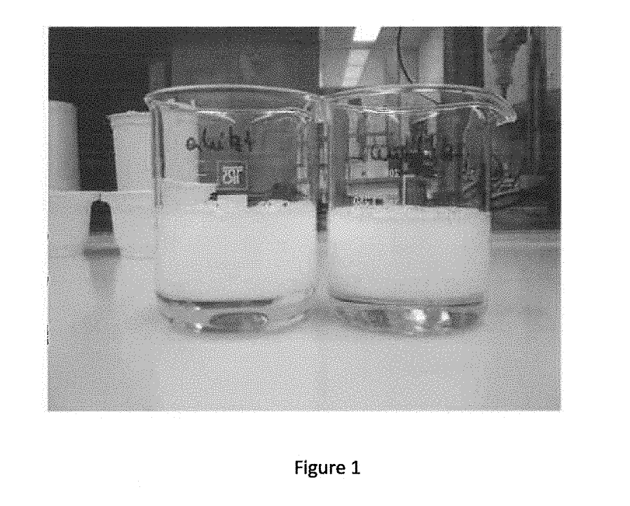

Surprisingly, it was found that, on the one hand, the permeates have a much higher foaming capacity than the skimmed milk itself, and that heat treatment has an influence both on foam height and foam stability on the other: the best results were obtained when the permeates were post-treated at temperatures of about 125° C. FIG. 1 shows the development of foam for examples 1 (right-hand side) and 2 directly after foaming.

### Example 2

3, 5 or 8 ml of milk permeate according to examples 1 to 4, respectively, were added to 100 g of skimmed milk. The samples were filled into the glass cylinder, foamed as described in example 1, and then the foam heights and foam stability were determined. The results are summarised in Table 2. Example 5 to 13 are according to the invention, example V2 serves comparison purposes.

TABLE 2
Foam height and foam stability (ml)

| | Permeate | | Immediately | | After |
|---|---|---|---|---|---|
| Expl. | Expl. | Quantity (g) | afterwards | After 5 min | 10 min |
| V2 | — | 0 | 40 | 20 | 0 |
| 5 | 2 | 3 | 60 | 40 | 10 |
| 6 | | 5 | 80 | 50 | 20 |
| 7 | | 8 | 90 | 50 | 20 |
| 8 | 3 | 3 | 80 | 60 | 30 |
| 9 | | 5 | 100 | 80 | 40 |
| 10 | | 8 | 100 | 80 | 40 |
| 11 | 4 | 3 | 50 | 30 | 10 |
| 12 | | 5 | 60 | 30 | 10 |
| 13 | | 8 | 60 | 20 | 10 |

Also in this experiment, the permeates heated at medium temperatures proved to be more effective than those obtained at lower or higher temperatures. Further, it was shown that an added quantity of 5% by weight is sufficient to create a high initial foam that remains stable for a sufficiently long time. Higher concentrations have ceased to lead to a proportional increase.

### Example 3

Skimmed milk was subjected to nanofiltration with a spiral coil membrane (separation performance 1,500 Dalton) at a temperature of 45° C. The permeates such obtained were placed into a measuring cylinder, either without undergoing heat treatment or after being heated to temperatures of between 95 and 140° C. for a period of 1 minute, were foamed with a stirrer at top speed for 1 minute, and subsequently, the foam height was determined as a function of time. The results are summarised in Table 3. Examples 14 to 17 are according to the invention, comparison example V3 was performed with skimmed milk.

TABLE 3
Foam height and foam stability (ml)

| | | Immediately | | | After |
|---|---|---|---|---|---|
| Expl. | Temperature | afterwards | After 5 min | After 10 min | 30 min |
| V3 | — | 40 | 20 | 0 | 0 |
| 14 | untreated | 100 | 70 | 60 | 10 |
| 15 | 95° C. | 180 | 160 | 100 | 40 |
| 16 | 125° C. | 220 | 190 | 170 | 120 |
| 17 | 140° C. | 150 | 110 | 90 | 20 |

Examples 14 to 17 show the same course as examples 1 to 4, however, ultimately, ultrafiltration proves to be superior to nanofiltration.

### Example 4

Skimmed milk concentrate was subjected to ultrafiltration with a spiral coil membrane (separation performance 25,000 Dalton) at a temperature of 45° C. The retentates such obtained were placed into a measuring cylinder, either without undergoing heat treatment or after being heated to temperatures of between 95 and 140° C. for a period of 1 minute, were foamed with a stirrer at top speed for 1 minute, and subsequently, the foam height was determined as a function of time. The results are summarised in Table 4. Examples 18 to 21 are according to the invention, comparison example V4 was performed with skimmed milk.

TABLE 4
Foam height and foam stability (ml)

| | | Immediately | | | After |
|---|---|---|---|---|---|
| Expl. | Temperature | afterwards | After 5 min | After 10 min | 30 min |
| V4 | — | 40 | 20 | 0 | 0 |
| 18 | untreated | 140 | 100 | 70 | 20 |
| 19 | 95° C. | 190 | 160 | 110 | 50 |
| 20 | 125° C. | 240 | 220 | 190 | 160 |
| 21 | 140° C. | 190 | 150 | 90 | 50 |

The permeates on the basis of skimmed milk concentrate proved to be substantially comparable with those on the basis of skimmed milk, even though also the permeates of skimmed milk received a slightly better evaluation.

### Example 5

Soured milk was subjected to ultrafiltration with a spiral coil membrane (separation performance 25,000 Dalton) at a temperature of 45° C. The permeates such obtained were placed into a measuring cylinder, either without undergoing heat treatment or after being heated to temperatures of between 95 and 140° C. for a period of 1 minute, were foamed with a stirrer at top speed for 1 minute, and subsequently, the foam height was determined as a function of time. The results are summarised in Table 5. Examples 22 to 25 are according to the invention, comparison example V5 was performed with skimmed milk.

TABLE 5
Foam height and foam stability (ml)

| | | Immediately | | | After |
|---|---|---|---|---|---|
| Expl. | Temperature | afterwards | After 5 min | After 10 min | 30 min |
| V5 | — | 40 | 20 | 0 | 0 |
| 22 | untreated | 80 | 50 | 30 | 10 |
| 23 | 95° C. | 100 | 90 | 50 | 20 |
| 24 | 125° C. | 110 | 100 | 50 | 20 |
| 25 | 140° C. | 80 | 50 | 30 | 10 |

The permeates on the basis of soured milk were also effective, but proved to be inferior to those on the basis of skimmed milk and of skimmed milk concentrate.

### Example 6

5 g permeate each were added to 100 g ayran according to examples 2, 19 and 23. The samples were filled into the glass cylinder, foamed as described in example 1, and then the foam heights and foam stability were determined. Subsequently, the taste of the products was evaluated by a panel consisting of 5 test persons according to the following scheme: (0)=no improvement (+)=slight improvement (++)=clear improvement. The results are summarised in Table 6. Examples 26 to 28 are according to the invention, comparison example V6 was performed with pure ayran.

TABLE 6
Foam height and foam stability (ml)

| | Permeate | | Immediately | | |
|---|---|---|---|---|---|
| Expl. | Expl. | Quantity (g) | afterwards | After 10 min | Taste |
| V6 | — | 10 | 0 | 0 | − |
| 26 | 2 | 50 | 30 | 20 | + |
| 27 | 19 | 40 | 30 | 10 | + |
| 28 | 23 | 40 | 20 | 10 | ++ |

The addition of all three permeates led to higher initial foam and improved foam stability, with the milk permeates scoring highest. Surprisingly, the greatest improvement of the taste was, however, achieved with the permeate on the basis of soured milk.

1. A foamable dairy composition, containing:
(a) at least one dairy product, and
(b) an additive which is obtained by subjecting a dairy product to filtration, separating the permeate, and, optionally, subjecting it to a thermal post-treatment.

2. The composition of claim 1, wherein the dairy product forming component (a) is selected from the group consisting of skimmed milk, milk with a set fat content, pasteurised milk, high temperature treated milk, ultra high temperature treated milk, condensed milk, whey, fine whey, soured milk, soured milk products, cream, yoghurt, kefir and ayran and mixtures thereof.

3. The composition of claim 1, wherein the additive forming component (b) represents the permeate obtained from the filtration of skimmed milk, skimmed milk concentrate, milk with a set fat content, concentrate of milk with a set fat content, pasteurised milk, high temperature treated milk, ultra high temperature treated milk, condensed milk, whey, fine whey, soured milk or soured milk products.

4. The composition of claim 1, wherein the additive forming component (b) represents the permeate obtained from diafiltration, microfiltration, ultrafiltration, nanofiltration, reverse osmosis, electrodialysis or a combination of these steps.

5. The composition of claim 1, wherein about 0.25 to about 20% by weight of the additive (b) is added to the dairy product (a).

6. A process for the production of a foamed milk composition, comprising the following steps:
(a1) providing a first dairy product (a);
(a2) providing a second dairy product (b);
(a3) subjecting the second dairy product to filtration, obtaining a permeate and a retentate;
(a4) optionally, heat treating the permeate;
(a5) adding the optionally heat-treated permeate obtained from the second dairy product (b) to the first dairy product (a); and
(a6) foaming the mixture while introducing air or inert gas, or
(b1) providing a first dairy product (a);
(b2) providing a second dairy product (b);
(b3) subjecting the second dairy product to filtration, obtaining a permeate and a retentate;
(b4) optionally, heat treating of the permeate;
(b5) foaming the optionally heat-treated permeate while introducing air or inert gas; and
(b6) adding the foamed permeate obtained from the second dairy product (b) to the first dairy product (a), or
(c1) providing a first dairy product (a);
(c2) providing a second dairy product (b);
(c3) subjecting the second dairy product to filtration, obtaining a permeate and a retentate;
(c4) optionally, heat treating the permeate;
(c5) adding the optionally heat-treated permeate obtained from the second dairy product (b) to the first dairy product (a);
(c6) heat treating the mixture; and
(c7) foaming the mixture while introducing air or inert gas.

7. The process of claim 6, wherein skimmed milk and/or its concentrates are subjected to ultrafiltration.

8. The process of claim 6, wherein ultrafiltration is performed with a membrane having an average pore size in the range from about 1,000 to about 50,000 Dalton and/or at temperatures in the range of 8 to 65° C.

9. The process of claim 6, wherein the permeates are subjected to heat treatment for a period from about 4 seconds to about 5 minutes and/or temperatures in the range from about 72 to about 150° C.

10. The process of claim 6, wherein about 0.5 to about 10% by weight of the permeate obtained from the dairy product (b) is added to the dairy product (a).

11. The process of claim 6, wherein the permeate, optionally after heat treatment, is added to skimmed milk or milk with a set fat content, subsequently subjecting it to pasteurisation, high temperature treatment or ultra high temperature treatment.

12. A method for foaming or stabilizing foaming of dairy products, comprising adding a permeate obtained from filtration of a dairy product as a foaming agent or foam stabilizer for the dairy products.

13. (canceled)

14. The method according to claim 12, wherein permeate obtained from ultrafiltration of skimmed milk and/or its concentrates is added.

15. The method according to claim 12, wherein the permeate is employed in quantities of about 0.25 to about 20% by weight, based on the dairy products.
